(19) United States
(12) Patent Application Publication
(10) Pub. No.: US 2011/0204674 A1
(43) Pub. Date: Aug. 25, 2011

(54) EXTENDER FOR A LIFTGATE

(76) Inventor: Brian E. Parnell, Gaines, MI (US)

(21) Appl. No.: 12/711,281

(22) Filed: Feb. 24, 2010

(51) Int. Cl. B60J 5/00

(52) U.S. Cl. 296/146.4

(57) ABSTRACT

A novel extender for maintaining a liftgate or similar feature on a motor vehicle in a secured and fixed open position is disclosed. The extender of the present invention includes a tubular member with a slot end and a hook end for respectively engaging the latch and the hasp of a locking mechanism. The extender being fitted between the latch and hasp of the locking mechanism can be locked into place thereby defining a fixed open distance for the liftgate while being resistant to removal.

### CROSS REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The present invention relates to lift gates for sport utility vehicles (SUVs) and the like. More particularly, the present invention relates to a lift gate extender for SUVs, vans, and similar vehicles that employ a lift gate.

The evolution of the motor vehicle has persisted over the last one hundred years, commencing with the so-called “horseless carriage” to Model T pickup trucks in short order. Since that time numerous utility type vehicles have been offered by the automotive manufacturers such that in recent decades there has been a convergence on certain types of designs.

One of the more prolific design features that has gained favor has been the liftgate which allows a user of a motor vehicle to access the rear compartment areas. In the case of pickup truck, the liftgate can be seen in use with truck caps that typically cover the pickup bed and provide an enhanced enclosed area. Where the truck cap meets the tailgate at the rear of the pickup truck, a liftgate is provided to allow the user to gain access to the enclosed area without the need for completely opening up the tailgate and then climbing into the rear of the truck.

The liftgate was also deployed on the very popular mini-vans and then on the SUVs. In the case of the mini-van the liftgate is used without the benefit of a true tailgate in most instances. The liftgate is elongated and is hinged near the roofline of the mini-van and results in a very large door that swings upwardly to allow access to the rear compartment area of the vehicle. In the case of the SUV, most designs seem to favor the combination tailgate and liftgate features which reduces the size of the liftgate to a modest assembly that can easily be handled. Nonetheless the liftgate shares the upward movement about a hinged top that is seen with the mini-vans although the user clearance is much reduced since the overall size of the liftgate is less than half that of the one used on the mini-van.

As one would expect, the existence of substantial cargo space at the rear of a vehicle is a highly attractive feature. Whether it is a pickup truck, mini-van or an SUV, the desirability of such vehicles lies in the occasional need for carrying a cargo. When this happens, users are sometimes confronted with situation that exceed the capacity or frustrate the capability of the particular vehicle. Sometimes this is due to the size of the cargo, such as those cases where it extends beyond the liftgate/tailgate of the vehicle, or in other case it arises from the nature of the cargo, such as pets like dogs, which need to have access to fresh air and ventilation. It happens therefore that a long-standing problem has arisen from such situations where the liftgate is not adequate to deal with the user's desires and objectives.

The problems associated with the typical liftgate design commence from the fact that once the liftgate is opened, even if for a little bit, security of the contents of the vehicle is compromised. In the case of materials and possessions, these are exposed to public generally and to criminals more specifically. In the case of pets like dogs, the choice between a closed or open liftgate is a real dilemma. If left open, the pet is able to jump out of the vehicle, or to be stolen by a passer-by. If the liftgate is left close, the pet does not have ventilation which as most people are aware, can be deadly to an animal left in a motor vehicle. Thus the user or owner of the pickup truck, mini-van or SUV is left with some difficult choices and issues.

It is an object of the present invention to allow for a liftgate extender that can securely hold a liftgate at a partially open position.

It is also another object of the present invention to allow for a liftgate extender that is compatible with the lock mechanism of the subject vehicle.

It is also a further object of the present invention to allow for a liftgate extender that is simple to use.

Lastly, it is an object of the present invention to provide for a liftgate extender that is comprised of a few parts and is very economical to purchase and use.

These and other objects and attributes of the present invention will be disclosed and discussed in more detail within this application.

### SUMMARY OF THE INVENTION

A liftgate extender for use in conjunction with a liftgate on a motor vehicle is comprised of a tubular member with a slot end and a hook end, where the hook end compatibly engages the hasp of the liftgate mechanism and where the slot end compatibly engages the latch of a lock mechanism provided with the liftgate and is lockable. The hook end of the liftgate extender further includes a threaded portion that is threaded into the tubular member and which is adjustable over a range of longitudinal adjustments. The hook end engages the hasp of the liftgate mechanism and is sized to ground out on the hasp base before allowing the hasp to become freed from the hook portion of the hook end.

The liftgate extender of the present invention further includes a preferred length whereby the distance of the opening provided by the extender between the liftgate sill and the edge of the liftgate is approximately eight inches in length.

### BRIEF DESCRIPTION OF THE DRAWINGS

FIG. 1 is a partial isometric view of an SUV showing an example of a liftgate of the type used in conjunction with the present invention.

FIG. 2 is an exploded isometric view of a lock assembly of the type commonly used in liftgate mechanisms and which is used in conjunction with the present invention.

FIG. 3 is an elevational view of the lock assembly of FIG. 2, where it is shown in oriented with respect to the hasp (or the hook) which is engaged with the striker of the lock assembly.

FIG. 4 is an isometric view of the extender of the present invention.

FIG. 5 is an elevational view of the extender of FIG. 4, where the hook end is engaged with the hasp of a liftgate (in phantom) and the slot end is engaged with the latch of a lock assembly of a liftgate (shown in phantom).

FIG. 6 is an elevational view of the hook end of the extender of FIG. 4 engaging a hasp of a liftgate.

FIG. 7 is an elevational view of the slot end of the extender of FIG. 4 engaging a latch of a lock assembly of a liftgate.

### DETAILED DESCRIPTION OF THE PREFERRED EMBODIMENTS

The popularity of SUVs and similar types of vehicles with liftgate type features has increased steadily over the past two decades. Part of this appeal comes from the fact that the vehicles offer the functionality of a passenger vehicle along with the utility of a work vehicle. The types of vehicles that employ liftgates, as mentioned above, include minivans and pickup trucks with caps, typically provide the user with dual purposes where they carry passengers and/or cargos depending on the user's requirements, thus the extender is very helpful in providing the secured openings needed for the carriage of pets or the retention of cargo in such applications. The extender of the present invention is also useful for retaining loads in the trunk compartments of the typical passenger vehicle as well. In this case the extender is used in between the trunk lid latch and the corresponding point on the vehicle body. While the usage of the invention in this manner may not necessarily be dedicated to the carriage of pets, the extender is particularly useful for the retention of cargo held in the trunk when the cargo is too large to allow the trunk lid to be closed. For the purposes of this application, the references to the SUV will be understood to encompass any application where a liftgate or similar gate or trunk lid is used in a motor vehicle, inclusive of passenger vehicles.

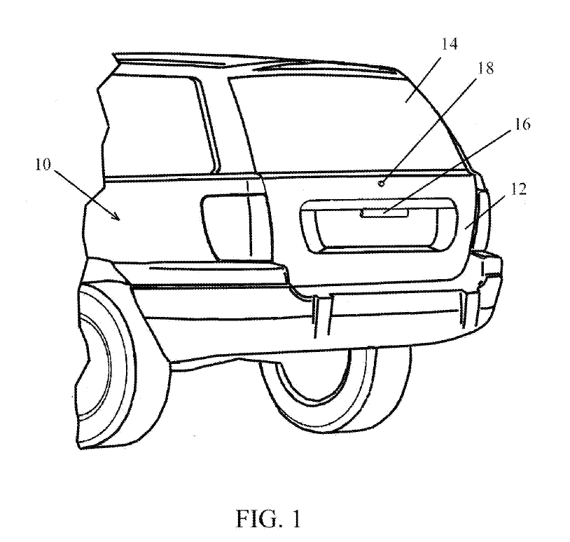

Turning now to FIG. 1, a typical SUV 10 is shown in a partial view with the tailgate 12, the liftgate 14, the handle 16 and the lock 18. This design is very commonly used and virtually every motor vehicle manufacturer produces a product of this type. In this case the liftgate 14 operates when unlocked and lifts upwardly to provide access to the cargo area enclosed at the rear of the SUV 10. This operation can occur independent from the tailgate 12 thus allowing the user to be able to reach in and load or unload cargo as desired.

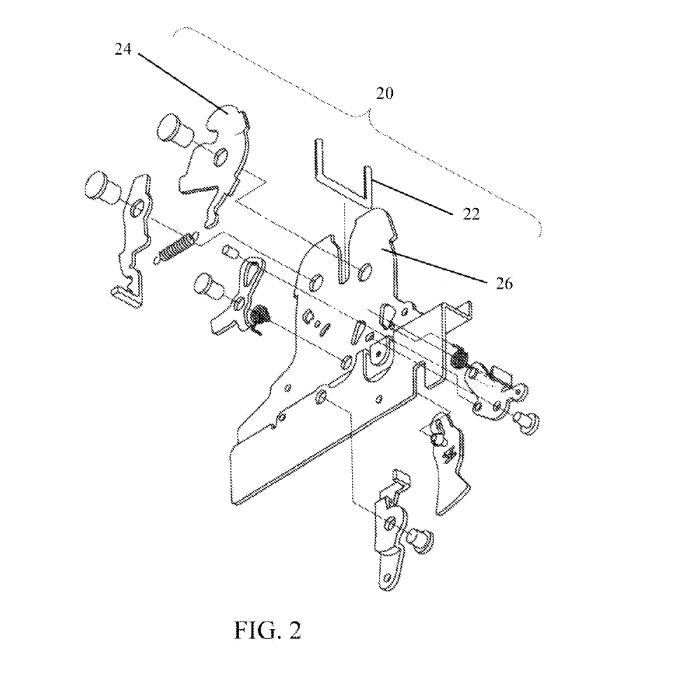

A lock assembly 20 is disclosed in FIG. 2 and is of a type that is commonly used in liftgate applications. The lock assembly 20 includes components that are pertinent to the use of the present invention and comprise the hasp 22, the latch 24 and the striker 26. In the drawing, the hasp 22 is shown in orientation to be fitted into the striker 26 where as will be understood more clearly below, the latch 26 can be rotated to engage the hasp 22.

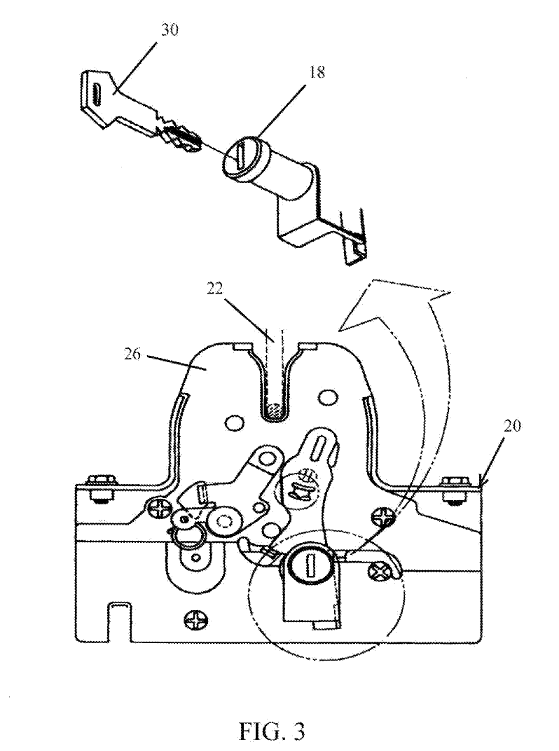

Further details of the lock assembly 20 are seen in FIG. 3 where the lock 18 is shown installed in the lock assembly 20. Also shown is the key 30 which is used to operate the lock 18.

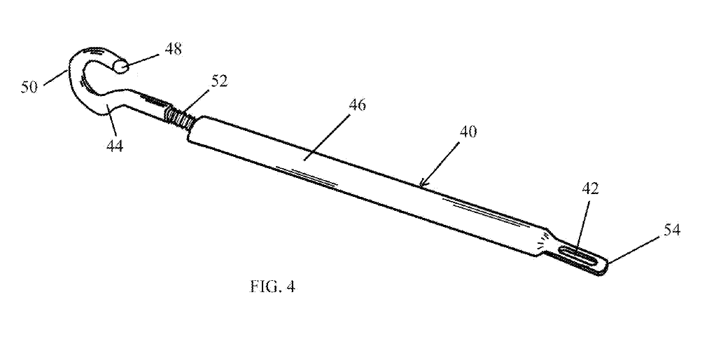

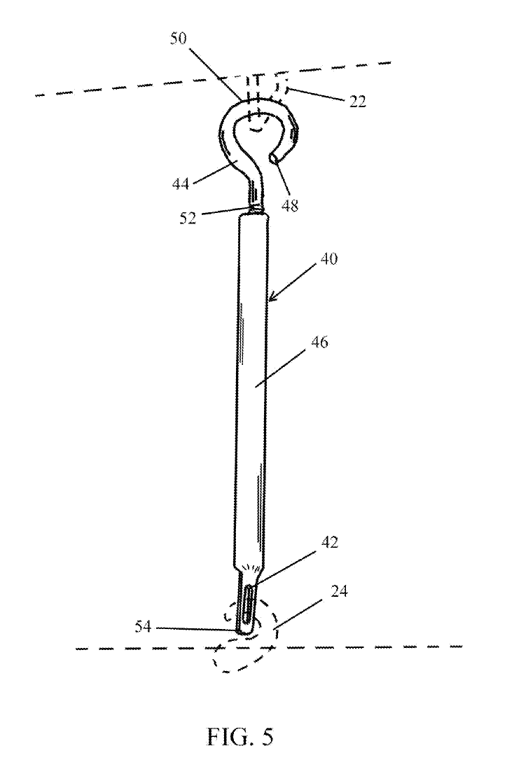

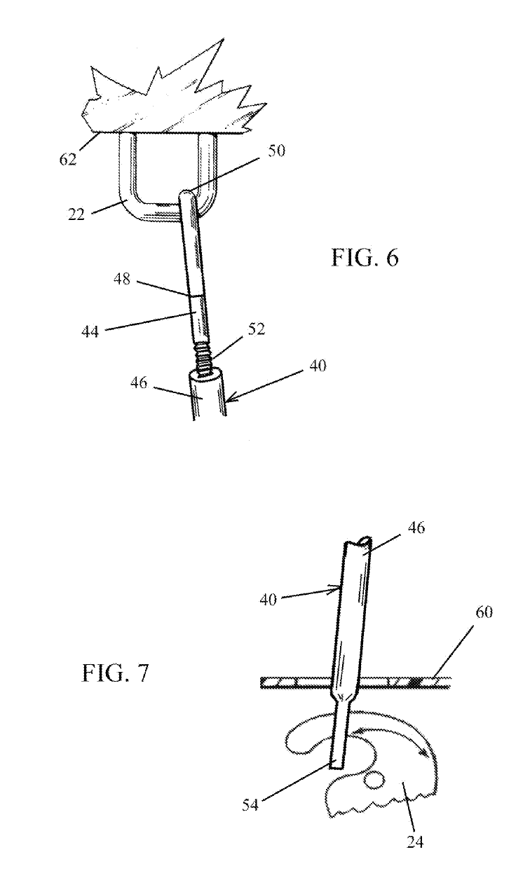

The extender 40 for use with a liftgate is shown in FIG. 4 and includes the slot 42, the hook 44, the tubular member 46, the hook end 48, the hook top 50, the threads 52 and the slot end 54. In FIG. 5 the extender 40 is shown in the installed condition where the latch 24 engages the slot 42 while at the same time the hook 44 is engaged with the hasp 22. More specifically, FIGS. 6 and 7 reveal the engagement of the hook 44 with the hasp 22 and the slot end 54 with the latch 24. From the drawings it can be seen that the hasp 22 is affixed to the hasp base 62 and that the latch 24 is located near the liftgate sill 60.

The function of the extender of the present invention is to provide a support for the liftgate that will retain the liftgate in a partially opened position and which will at the same time retain the locking function of the liftgate. This is an important consideration in many different circumstances but it has been found to be especially useful when one has pets (dogs) riding in the cargo area of an SUV. With the use of the extender, the pets can have adequate ventilation without the fear that the liftgate will open all the way or that third persons could access the cargo area. The advisability of using the extender for ventilation purposes will need to be considered on a case-by-case basis such that if it is used when the vehicle is in motion, there must be sufficient confidence that the pet will not be able to get through the opening created. While this doesn't necessarily pose a problem based on applicant's uses of the device thus far, the consideration is prudent and a matter of common sense. The extender provides an adjustable range of openings between the liftgate sill and the liftgate to the user by screwing the hook into or out of the tubular member by means of the threaded portion of the hook. The tubular member is provided with a captured nut or a threaded receiving portion compatible with the threaded portion on the hook, in any manner which is well known in the art. A preferred range of openings is 6-10 inches, wherein 8 inches is especially useful for providing the ventilation requirements for an average sized dog without allowing too much clearance for the dog to exit the vehicle. In other uses the extender can be deployed when the user is carrying cargo that exceeds the length of the cargo area in the vehicle. For instance, if the user is transporting lengths of lumber or wood pieces that extend outward from the tailgate, the extender can be used to keep the liftgate in a defined and selected position while maintaining the locking function of the liftgate. The sizing of the tubular member and its threaded portion, the hook and the length of the slot end all combine to provide the desired range of openings which is a matter of an engineering selection.

As may be appreciated from the drawings, the extender utilizes the hasp and the latch of the existing tailgate assembly in the typical SUV. In particular the slot of the extender is sized to receive the latch of the lock assembly such that the lock and lock assembly function the same way as if the hasp is received by the striker. Thus there is no need to provide any auxiliary locking mechanism to supplement the extended; it works with the OEM locking system of the liftgate.

It is understood that the orientation of the hasp and latch may be modified from the orientation that is presented herein without departing from the functionality and benefits of the present invention. For instance, where the drawings indicate the lock assembly to be located in the liftgate sill and the hasp on the lower end on the liftgate, these locations can be reversed in some cases. The situation is case specific for each vehicle manufacturer although it is understood that the extender will work within such circumstances where the compatibility between the engagement of the hook portion and the slot portion of the extender and the hasp and the latch respectively still exists. In addition, the lock assembly shown is by way of example. There are other types of lock assemblies that can be used where the latch may vary somewhat, however so long as the latch is engageable with the slot end of the extender the present invention would be applicable.

The materials of choice for the fabrication of the extender are typically metals, and typically these are steel. The tubular member may a hollow tube where the slot end is worked to be flattened and to provide a slot. The other end is fabricated to include a compatible receiver for the threaded end of the hook such that the hook can be turned in and out from the tubular member thereby adjusting the overall length of the extender in accordance with the objectives of the user. The hook is fabricated from steel and is formed with a threaded end that is compatible with insertion and engagement with the tubular member.

In use, the hook is engaged with the hasp before the slot end is inserted into position for engagement with the latch. The engagement of the latch with the slot of the extender occurs when the key is rotated in the lock and the latch is rotated into an engaged position as may be understood from the drawings. The hook is sized such that when installed, the hook top grounds out on the hasp base before the hasp can reach the opening in the hook and be released. This means that the only way the extender can be removed from the installation is by unlocking the lock assembly which occurs when the latch is rotated back to an open and disengaged position, thereby allowing the slot end of the extender to be freed and removeable from the lock assembly.

The uses and applications of the present invention that have been discussed herein are meant by way of illustration and not by limitation. The extender may be successfully used on pickup truck caps, minivans and other liftgate type applications where the objectives for deploying an extender are indicated. Other variations in the type of hook, or slot end, or the selection of materials are possible and are not meant to be excluded from consideration.

I claim:

1. An extender for a motor vehicle with a liftgate that opens and closes where the extender maintains the liftgate in a open position at a pre-set distance, the liftgate having a lock mechanism including a hasp and a latch compatibly mounted onto the liftgate and the liftgate sill, the extender of the present invention comprising:
A tubular member with a hook end and a slot end distally opposed thereon, where the hook end compatibly engages the hasp and the slot end is engageable with the latch, said extender being fixed in between the hasp and the latch when the lock mechanism is locked, the overall length of the tubular member with its slot end and hook end defining a fixed distance for which the liftgate is secured in an open position.

2. The extender of claim 1, where hook end comprises a hook that is compatibly sized to engage the hasp and to be unremovable from the hasp when the extender is in the locked condition.

3. The extender of claim 1, where the hook end is threadably adjustable to lengthen and shorten the overall length of the tubular member with associated slot end and hook end.

4. The extender of claim 1, where the slot end is engageable with the original equipment manufacturer (OEM) lock mechanism of the motor vehicle.

5. The extender of claim 1, where the preferred distance for maintaining the liftgate in an open position is in the range of six inches (6″) to ten inches (10″).

6. An extender for a motor vehicle with a liftgate that opens and closes where the extender maintains the liftgate in a open position at a pre-set distance, the liftgate having a lock mechanism including a hasp and a latch compatibly mounted onto the liftgate and the liftgate sill, the extender of the present invention comprising:
A tubular member with a hook end threadably affixed to said tubular member, and a slot end distally opposed to said hook end, where the hook end compatibly engages the hasp and the slot end is engageable with the latch, said extender being fixed in between the hasp and the latch when the lock mechanism is locked and unremovable therefrom, the overall length of the tubular member with its slot end and hook end defining a fixed distance for which the liftgate is secured in an open position.

7. The extender of claim 6, where the hook end is threadably adjustable to lengthen and shorten the overall length of the tubular member with associated slot end and hook end.

8. The extender of claim 6, where the slot end is engageable with the original equipment manufacturer (OEM) lock mechanism of the motor vehicle.

9. The extender of claim 6, where the preferred distance for maintaining the liftgate in an open position is in the range of six inches (6″) to ten inches (10″).

10. An extender for a motor vehicle with a gate that opens and closes and where the gate utilizes a lock mechanism with a hasp and a latch, the extender of the present invention comprising:
A tubular member with a hook end affixed to said tubular member at one end, and a slot end projecting from the tubular member at its other end, where the hook end compatibly engages the hasp and the slot end engages the latch, said extender being fixed in between the hasp and the latch when the lock mechanism is locked and unremovable therefrom, the overall length of the tubular member with its slot end and hook end defining a fixed distance for which the gate is secured in an open position.

11. The extender of claim 10, where the hook end is threadably adjustable to lengthen and shorten the overall length of the tubular member with associated slot end and hook end.

12. The extender of claim 10, where the slot end is engageable with the original equipment manufacturer (OEM) lock mechanism of the motor vehicle.

13. The extender of claim 10, where the preferred distance for maintaining the gate in an open position is in the range of six inches (6″) to ten inches (10″).
